(19) United States
(12) Patent Application Publication
(10) Pub. No.: US 2010/0277887 A1
(43) Pub. Date: Nov. 4, 2010

(54) POLARIZED WHITE LIGHT EMITTING DIODE

(75) Inventors: Jung-Chieh Su, Taipei City (TW); Che-Wei Hsu, Taipei City (TW)

Correspondence Address: QUINTERO LAW OFFICE, PC, 615 Hampton Dr, Suite A202, Venice, CA, 90291, US

(73) Assignee: National Taiwan University of Science & Technology, Taipei City (TW)

(21) Appl. No.: 12/502,133

(22) Filed: Jul. 13, 2009

(30) Foreign Application Priority Data
May 1, 2009 (TW) TW98114609

(51) Int. Cl. F21V 9/14

(52) U.S. Cl. 362/19

(57) ABSTRACT

A polarized white light emitting diode is provided, including a substrate with an ultraviolet light emitting diode (UV LED) chip disposed thereover for emitting ultraviolet (UV) light, a phosphor layer coated around the UV LED chip to be excited by the UV light from the UV LED chip to thereby emit white light, an omni-directional reflector disposed over the phosphor layer, a medium layer disposed between the omni-directional reflector and the phosphor layer, wherein the omni-directional reflector allows the UV light from the UV LED chip to be multiply and omni-directionally reflected in between the phosphor layer and the medium layer, a transparent substrate disposed over the omni-directional reflector, and a metal-containing polarization layer disposed over the transparent substrate for polarizing the white light emitted from the phosphor layer to thereby emit a polarized white light

### CROSS REFERENCE TO RELATED APPLICATIONS

This Application claims priority of Taiwan Patent Application No. 98114609, filed on May 1, 2009, the entirety of which is incorporated by reference herein.

### BACKGROUND OF THE INVENTION

1. Field of the Invention

The present invention relates to light emitting diodes (LEDs), and in particular relates to a polarized white light emitting diode capable of emitting polarized white light.

2. Description of the Related Art

White light-emitting diodes (LEDs) are point light sources that are packaged as a matrix LED for illumination. White light is produced by combining at least two chromatic lights with various wavelengths, such as blue and yellow light or blue, green and red light.

Because light sources emitting light in spectrum ranges closer to sunlight are desirable, white LEDs with specific spectrums, color renderings and correlated color temperatures (CCTs) similar to sunlight have been developed. The color rendering index (CRI) represents the real color exhibition of an object compared to sunlight when a light source is irradiating on the object. Illumination requirements for home and industrial use are different. In the home, warm white light sources with low color temperature is required, for example, a conventional tungsten-filament bulb. To the contrary, high color temperature illumination is required for industrial use. Additionally, for LCD panels, a sufficient gamut of backlight (a light source) is required. Thus, various light sources have various illumination requirements, and are designed to meet those requirements.

One type of commercially available white LED uses blue LED to excite yellow phosphor grains to produce white light. The blue LED is covered by an optical resin mixed with yellow phosphor grains. The blue LED emits blue light with a wavelength of 400-530 nm. The yellow phosphor grains are excited by the blue light emitted from the blue LED to produce yellow light, and the product is combined with a proper amount of emitted blue light to produce the white light.

However, the white LED using the blue LED to excite the yellow phosphor grains suffers from some drawbacks. First, high color temperatures and non-uniform illuminated light are generated due to the blue light. Therefore, interaction between the blue light and the yellow phosphor grains is required to reduce the intensity of the blue light or increase yellow light intensity is increased to decrease color temperatures and uniform illuminated light. Second, the wavelength of blue light shifts as temperature increases, resulting in color shift of the white light emission. Third, insufficient color rendering occurs due to lack of the intensity of red light. Although red phosphor grains can be added to improve color rendering, color shift still occurs. Fourth, the emitted white light produced is non-polarized white light, which results in a glare, limiting uses thereof.

Therefore, another type of white LED has been disclosed, using ultraviolet (UV) LEDs to excite blue, green and red phosphor grains mixed in a transparent optical resin with a specific ratio, similar to the method for generating white light of fluorescent lamps. The produced white light is uniform, and with high color rendering, without color shift. However, the luminous efficiency thereof is low and UV light emission is a problem. Additionally, the emitted white light is still non-polarized light, thereby limiting applications.

Since the conventional white LEDs using even LED chips emitting blue light or UV light both fails to illuminate polarized white light capable of illumination applications. Moreover, the conventional fluorescent bulbs, electronic energy-saving tubes, and fluorescent lamps are all non-polarized light sources. An additional polarization sheet is needed to be provided to produce polarized white light for illumination applications, an additional polarization sheet is needed to be added to non-polarized light sources. However, brightness of the light sources is reduced and the polarization sheet deteriorates over time.

### BRIEF SUMMARY OF THE INVENTION

Therefore, polarized white light emitting diodes are provided to overcome the above mentioned problems.

An exemplary polarized white light emitting diode comprises a substrate with a circuit formed thereon. An ultraviolet light emitting diode (UV LED) chip is disposed over the substrate and electrically connected with the circuit, wherein the UV LED chip has an emission surface for emitting ultraviolet (UV) light. A phosphor layer is coated around the UV LED chip, wherein the phosphor layer is formed by blending multi-color phosphor grains with a transparent optical resin, and the multi-color phosphor grains in the transparent optical resin are excited by the UV light from the UV LED chip to thereby emit white light. An omni-directional reflector is disposed over the phosphor layer and opposite to the emission surface of the UV LED chip. A medium is disposed between the omni-directional reflector and the phosphor layer, wherein the medium has a reflective index of less than that of the phosphor layer and the omni-directional reflector for allowing the UV light from the UV LED chip to be multiply and omni-directionally reflected in the phosphor layer and the medium. A transparent substrate is disposed over the omni-directional reflector, wherein the transparent substrate has opposite first and second surfaces, and the first surface of the transparent substrate is in contact with the omni-directional reflector. A metal-containing polarization layer is disposed on the second surface of the transparent substrate, wherein the metal-containing polarization layer polarizes the white light emitted from the phosphor layer and passed through the transparent substrate to thereby emit a polarized white light.

Another exemplary polarized white light emitting diode comprises a reflective substrate having first and second recesses formed therein, wherein the first recess is formed below the second recess. An ultraviolet light emitting diode (UV LED) chip is disposed on the reflective substrate exposed by the first recess, wherein the UV LED chip has an emission surface for emitting ultraviolet light. A transparent layer coated around the UV LED chip, fills the first recess. A phosphor layer fills the second recess to cover the transparent layer, wherein the phosphor layer is formed by blending multi-color phosphor grains with a transparent optical resin, and the multi-color phosphor grains in the transparent optical resin are excited by the UV light emitted from the UV LED chip to thereby emit white light. A pair of metal electrode is formed through the second recess along opposite sidewalls of the reflective substrate, respectively. A pair of bond wires connects to two of the metal electrodes with the UV LED chip, respectively. An omni-directional reflector is disposed over the phosphor layer and opposite to the emission surface of the UV LED chip. A medium is disposed between the omni-directional reflector and the phosphor resin layer. A transparent substrate is disposed over the omni-directional reflector, wherein the transparent substrate has opposite first and second surfaces, and the first surface of the transparent substrate is in contact with the omni-directional reflector. A metal-containing polarization layer is disposed on the second surface of the transparent substrate, wherein the metal-containing polarization layer polarizes the white light emitted from the phosphor layer and passed through the transparent substrate to thereby emit a polarized white light.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is cross section of a polarized white light emitting diode according to an embodiment of the invention;

FIG. 2 is cross section of an omni-directional reflector according to an embodiment of the invention;

FIG. 3 is a schematic structure of an micro-optical component according to an embodiment of the invention;

FIG. 4 is a schematic structure of an micro-optical component according to another embodiment of the invention;

FIG. 5 is cross section of a polarized white light emitting diode according to another embodiment of the invention;

FIG. 6 is cross section of a polarized white light emitting diode according to yet another embodiment of the invention; and

FIG. 7 is a simulated result showing an average reflectance in full-spectrum range of a polarized white light emitting diode according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

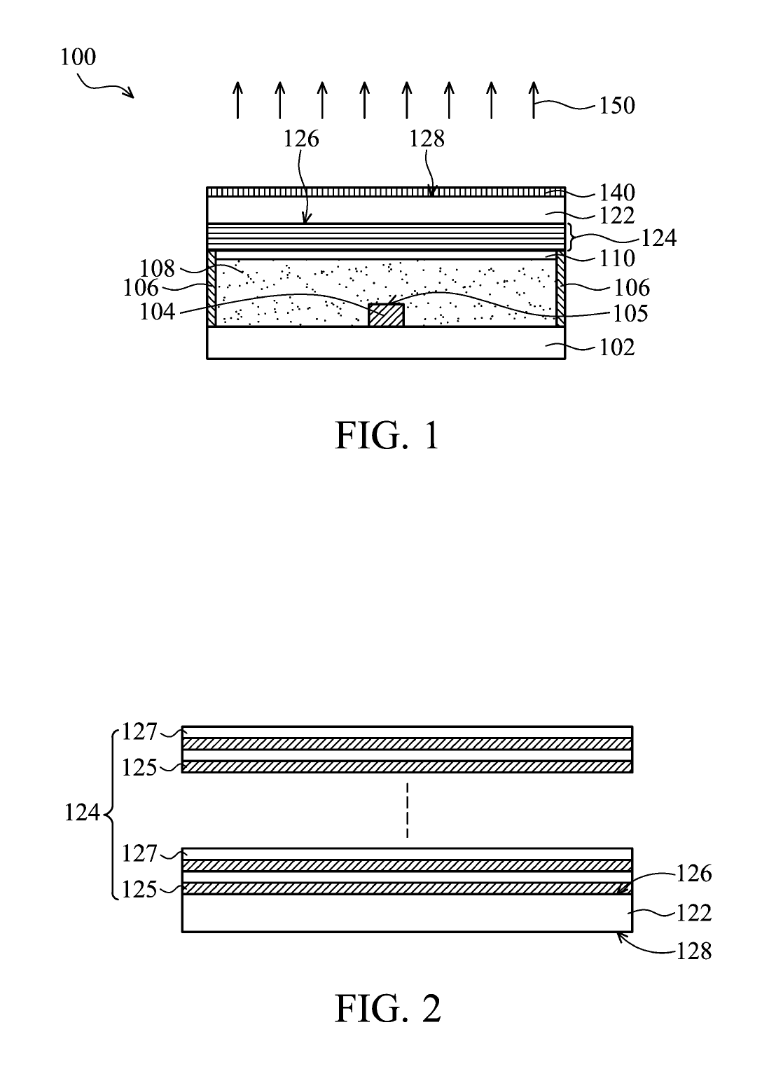

FIGS. 1-6 are schematic diagrams illustrating various exemplary polarized white light emitting diodes.

In FIG. 1, a polarized white light emitting diode 100 is illustrated, comprising a substrate 102, an ultraviolet light emitting diode (UV LED) chip 104, a phosphor layer 108, an omni-directional reflector 124, a transparent substrate 122, a side reflector 106, and a metal-containing polarization layer 140. A medium 110 is disposed between the phosphor layer 108 and the omni-directional reflector 124 to isolate the phosphor layer 108 from the omni-directional reflector 124. The omni-directional reflector 124 improves luminous efficiency of the polarized white LED 100 and prevents ultraviolet light emission from the UV LED chip 104 emitted from the polarized white LED 100. In addition, with the use of the metal-containing polarization layer 140, white light emitted from the polarized white LED 100 can be polarized to generate polarized white light 150 emitted from the polarized white LED 100. Structures and functionalities of the components of the polarized white LED 100 in this embodiment will be discussed in detail as follows.

As shown in FIG. 1, the substrate 102 in this embodiment can be a circuit substrate with predetermined electrodes such as positive and negative electrodes (not shown) or a circuit element such as a circuit (not shown). The substrate 102 may also reflect the visible light produced by exciting the phosphor grains of predetermined colors (not shown) in the phosphor layer 108 with the UV light emitted by the UV LED chip 104. Herein, the UV LED chip 104 is disposed over the substrate 102 and can be driven by applying currents thereover to emit UV light. The UV light can be emitted from an emission surface 105 of the UV LED chip 104, thereby functioning as a light source for exciting the phosphor layer 108.

In this embodiment, only one UV LED chip 104 is illustrated and provided in the polarized white light emitting diode 100. However, to meet various light intensity requirements, one or more UV LED chip 104 can be formed over the substrate 102 in, for example, an array configuration. A plurality of circuits (not shown) can be also fabricated over the substrate 102 and then the UV LED chips 104 are respectively disposed over a corresponding circuit formed over the substrate 102. The phosphor layer 108 can be coated over the substrate 102 and surrounds the UV LED chip 104, and the phosphor grains in the phosphor layer 108 can be excited while UV light passes therethrough to generate white light.

In one embodiment, the phosphor layer 108 may comprise transparent optical resin blending with phosphor grains of predetermined colors and predetermined ratios. The UV LED chip 104 may comprise III-V photosemiconductor chips, for example, GaN, InGaAlN or AlGaN chips. The phosphor layer 108 may comprise transparent resin such as epoxy or silicon resin which is transmissive to UV light and visible light. The phosphor grains in the phosphor layer 108 may be of blue, yellow and red colors, wherein the yellow phosphor grains may comprise one of YAG, TAG and BOS phosphor grains. The ultraviolet light-emitting diode 104 emits ultraviolet (UV) light with a wavelength of 320-400 nm to excite the blue and red phosphor grains in the phosphor layer 108 and emits blue and red lights. The yellow phosphor grains are excited by blue light with a wavelength of about 400-530 nm emitted from the blue phosphor grains to emit yellow light. The remaining blue light is then combined with the yellow and red light to form white light.

The omni-directional reflector 124 is disposed over the phosphor layer 108 and is oppositely disposed over the emission surface 105 of the UV LED chip 104. The UV LED chip 104 and the phosphor layer 108 are isolated by the medium 110. The medium 110 may have a refractive index of less than the refractive index of the phosphor layer 108 and the omni-directional reflector 124, such as about of 1˜1.5. In one embodiment, the medium 110 can be, for example, an air gap.

In FIG. 2, an exemplary embodiment of the omni-directional reflector 124 in FIG. 1 is illustrated. Herein, the omni-directional reflector 124 can be formed over a surface 126 of the transparent substrate 122 by methods such as sputtering, electro-gun (E-gun), or chemical vapor deposition. Materials and thickness of the coating layers of the omni-directional reflector 124 can be chosen to meet predetermined optical reflectance requirements, to reflect light of a predetermined wavelength from the UV LED chip 104 and not reflect visible light generated by excitation of the phosphor layer 108. Thus, the omni-directional reflector 124 is now designed for the UV LED chip 104 and performs a high reflectance more than 90% to the emitting light with all emitting angles and different electric field polarizations.

In this embodiment, the omni-directional reflector 124 is formed by alternately depositing a low refractive index layer 125 and a high refractive index layer 127 on the surface 126 of the transparent substrate 122. The transparent substrate 122 comprises highly transmissive materials, such as glass, to visible light generated by excitation of the phosphor layer 108. The low refractive index layer 125 is a layer having a refractive index of less than that of the high refractive index layer 127 and has a refractive index of about 1.4-1.9. The low refractive index layer 125 comprises materials such as SiO₂, Al₂O₃, MgO, La₂O₃, Yb₂O₃, Y₂O₃, Sc₂O₃, WO₃, LiF, NaF, MgF₂, CaF₂, SrF₂, BaF₂, AlF₃, LaF₃, NdF₃, YF₃, CeF₃ or combinations thereof. The high refractive index layer 127 has a refractive index of more than that of the low refractive index layer 125 and has a refractive index of about 2-3. The high refractive index layer 127 comprises materials such as TiO₂, Ta₂O₅, ZrO₂, ZnO, Nd₂O₃, Nb₂O₅, In₂O₃, SnO₂, SbO₃, HfO₂, CeO₂, ZnS, or combinations thereof.

In FIG. 1, a side reflector 106 is formed around the phosphor layer 108 to thereby reflect UV light back to the phosphor layer 108. Thus, the UV light emitted from the UV LED chip 104 may incident into the omni-directional reflector 124 formed over the phosphor layer 108 in all angles. However, since the omni-directional reflector 124 and the side reflector 106 around the phosphor layer 108 reflect light wave of predetermined wavelength, the UV light emitted from the UV LED chip 104 is limited between the circuit substrate 102 having reflecting functionality (to UV light and visible light) and the omni-directional reflector 124. With the use of the side reflector 106, the UV light emitted from the UV LED chip 124 can be repeatedly and multi-directionally reflected in the phosphor layer 108 and the medium 110.

Whenever the UV light from the UV LED chip 104 passes through the phosphor layer 108, the phosphor grains in the phosphor layer 108 will be excited and emit secondary visible light. The secondary visible light reflected in the space between the omni-directional reflector 124, the substrate 102 and the side reflector 106 excite the phosphor grains in the phosphor layer 108 and exhaust the energy of the UV light from the UV LED chip 104 to improve light-wavelength conversion efficiency of the phosphor grains and make the polarized white light emitting diode 100 to emit a maximum amount of white light.

As shown in FIG. 1, a metal-containing polarization layer 140 is formed over a surface 128 of the transparent substrate 122 opposite to the surface 126 of the transparent substrate 122 having the omni-directional reflector 124 formed thereover. With the use of the metal-containing polarization layer 140, predetermined light components in the white light passing through the omni-directional reflector 124 and the transparent substrate 122 and arriving at an interface between the metal-containing polarization layer and the transparent substrate 122 which meets the polarization conditions of the metal-containing polarization layer 140, continuously passes through the metal-containing polarization layer 140, thereby obtaining the polarized white light 150 emitted from the polarized white LED 100. Light components in the white light passing through the omni-directional reflector 124 and the transparent substrate 122 and arriving at the interface between the metal-containing polarization layer and the transparent substrate 122 which does not meet the polarization conditions of the metal-containing polarization layer 140 is blocked and is continuously reflected in the transparent substrate 122 between the metal-containing polarization layer 140 and the omni-directional reflector 124 until the polarization conditions of the metal-containing polarization layer 140 are met and then emitted by the polarized white LED 100 in the form of the polarized white light 150.

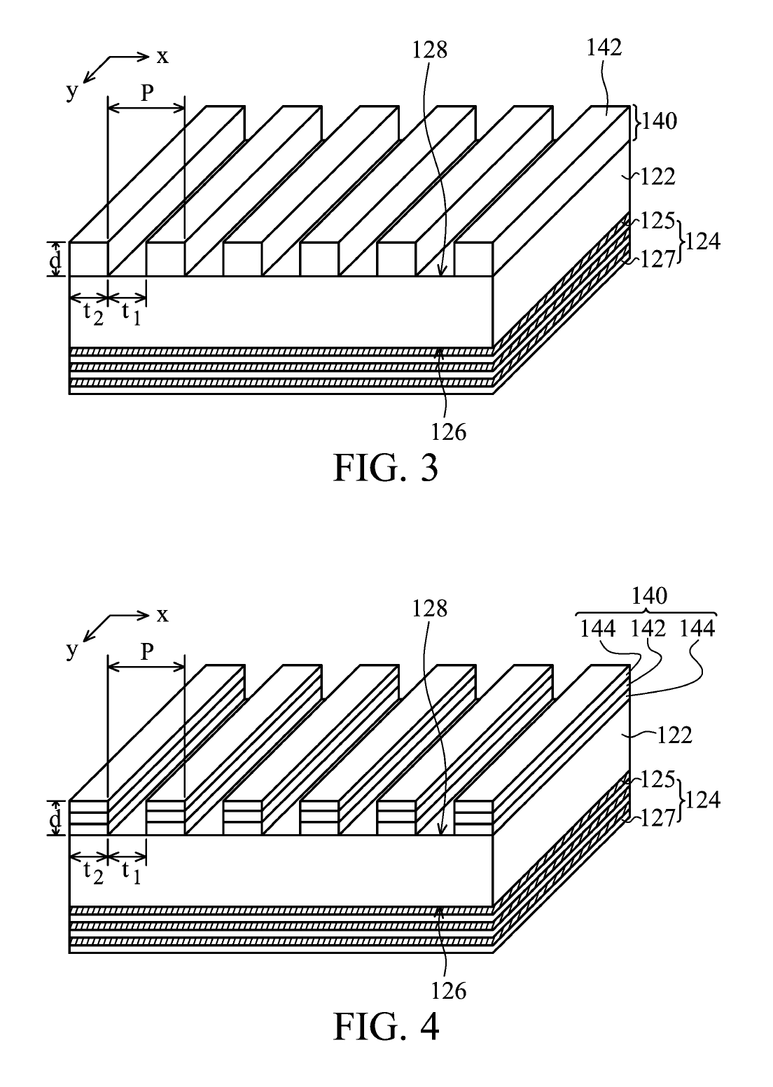

FIG. 3 shows a schematic structure partially illustrating micro-optical components such as the metal-containing polarization layer 140, the transparent substrate 122 and the omni-directional reflector 124 in the polarized white LED 100. As shown in FIG. 3, the metal-containing polarization layer 140 is formed as a configuration of a sub-wavelength grating having a plurality of spaced and parallel metal lines 142. As shown in FIG. 3, the metal lines 142 are parallel arranged along a y direction. The metal lines 142 have a line width t₂ of about 30-180 nm and a thickness d of about 30-200 nm. The metal lines 142 have a duty cycle of about 10-60% and are arranged over the surface 128 of the transparent substrate 122 according a cycle P 300 nm or less. In one embodiment, TM (transverse magnetic filed) light components of the white light passing through the omni-directional reflector 124 that meet the polarization conditions of the metal-containing polarization layer 140 pass through the metal-containing polarization layer 140 to provide the emitted polarization white light (see FIG. 1). TE (transverse electric filed) light components of the white light passing through the omni-directional reflector 124 that do not meet the polarization conditions of the metal-containing polarization layer 140 are blocked by the metal-containing polarization layer 140 and then repeatedly reflected at the surface 128 of the transparent substrate 122 and in the transparent substrate 122 until the polarization conditions of the metal-containing polarization layer 140 are met, to thereby provide the emitted polarization white light 150 (see FIG. 1).

Fabrication of the metal-containing polarization layer 140 shown in FIG. 3 is described as follows. A resist layer (not shown) of sub-wavelength patterns are formed over the surface 128 of the transparent substrate 122 by methods such as a holographic interference method. A metal film of material such as aluminum is then coated over the resist layer. The resist layer and the portion of the metal layer formed thereover are then removed by a lift-off method and a plurality of metal lines 142 for forming the metal-containing polarization layer 140 is thus formed over the surface 128 of the transparent substrate 122. In this embodiment, the metal-containing polarization layer 140 has the functionality of a nano-wire grid polarizer and allows multiple reflections and polarizations of the white light passing through the omni-directional reflector 124 and the transparent substrate 122, thereby emitting polarized white light 150 by the polarized white LED 100. Meanwhile, formation of the metal lines 142 in the metal-containing polarization layer 140 is not restricted by the configuration illustrated in FIG. 3. The metal lines 142 can be formed and arranged along the x direction in FIG. 3 or in other configurations. In addition, the polarized white light 150 in this embodiment is linear polarized light.

As shown in FIG. 4, the metal-containing polarization layer 140 in another embodiment is a sub-wavelength grating formed of a multiple layer coating comprising a plurality of dielectric layers 144 and at least one metal layer 142 but not the sub-wavelength grating formed by the single metal layer illustrated in FIG. 3. In this embodiment, the metal-containing polarization layer 140 can be formed by the above described methods. The multiple coating layers for forming the metal-containing polarization layer 140 comprise at least one metal layer 142 and are not limited by the illustration in FIG. 4. The dielectric layer 144 can be visible light transparent dielectric materials such as silicon dioxide, titanium dioxide, and the metal layer 142 may comprise aluminum.

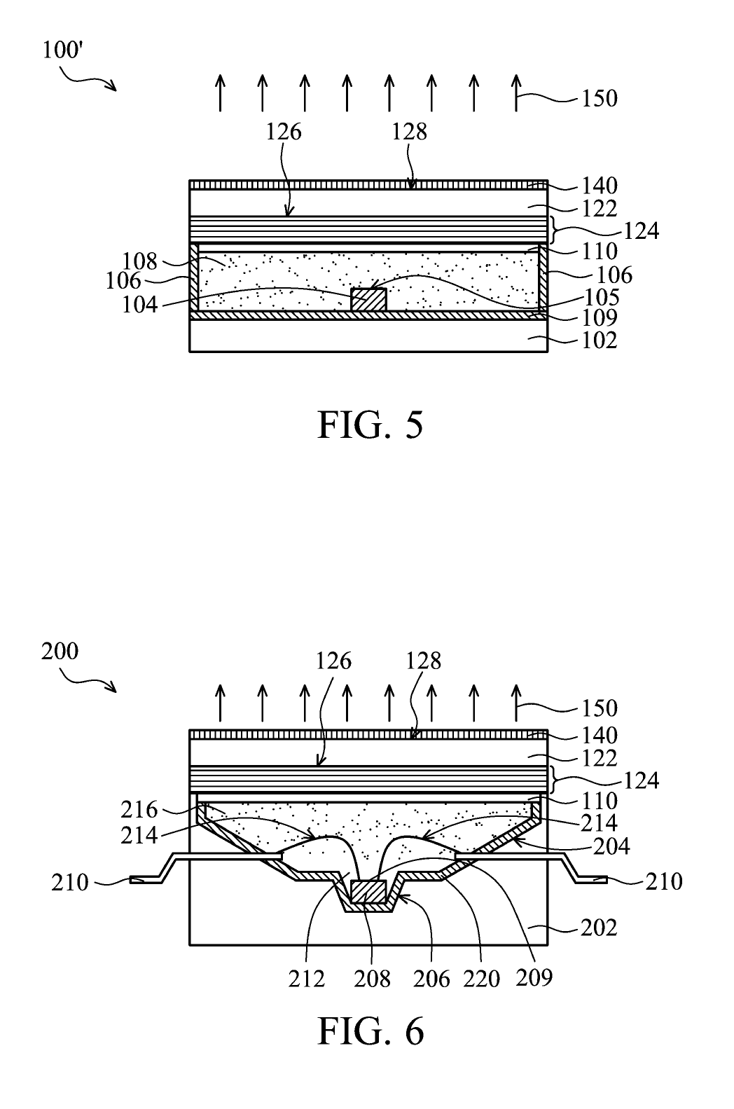

FIG. 5 is another polarized white light emitting diode 100′, having a structure substantially the same as the polarized white light emitting diode 100 illustrated in FIG. 1. A difference therebetween is a reflection layer 109 formed at a side opposite to the omni-directional reflector 124 on the substrate 102. With the use of the reflection layer 109, a pumping cavity structure is formed in the polarization white light emitting diode 100′, thereby allowing multiple reflection of the light emitted by the UV LED chip 104 between the omni-directional reflector 124 and reflection layer 109 to excite the phosphor grains in the phosphor layer 108 and exhaust the energy of the UV light from the UV LED chip 104 to thereby improve light-wavelength conversion efficiency of the phosphor grains and make the polarized white light emitting diode 100′ emit maximum white light. The reflection layer 109 may comprise materials such as Al, Cu, Ag and Au which are reflective to both UV light and visible light.

In FIG. 6, another exemplary polarized white light emitting diode 200 is illustrated. The polarized white light emitting diode 200 is similar with the polarized white light emitting diode 100 illustrated in FIG. 1 and differences therebetween are components such the substrate, reflective elements and locations of the UV LED chip. As shown in FIG. 6, the polarized white light emitting diode 200 includes a substrate 202, a UV LED chip 208, a transparent layer 212, a phosphor layer 216, a reflective layer 220, an omni-directional reflector 124, a transparent substrate 122 and a metal-containing polarization layer 140. A medium 110 is provided between the phosphor layer 216 and the omni-directional reflector 124 to isolate the phosphor layer 216 and the omni-directional reflector 124. With the use of the omni-directional reflector 124, a luminous efficiency of the polarized white LED 200 is improved and ultraviolet light emission from the UV LED chip 208 is prevented. In addition, with the use of the metal-containing polarization layer 140, white light emitted from the polarized white LED 200 is polarized to polarized white light, thereby generating polarized white light 150 emitted from the polarized white LED 200. Structures and functionalities of the components of the polarized white LED 200 in this embodiment will be discussed in detail as follows.

As shown in FIG. 6, the substrate 202 in this embodiment is a substrate with a reflective surface and may comprise materials such as Al, Si or ceramics. Recesses 204 and recess 206 can be formed in the substrate 202 by suitable processing techniques. Herein, the recess 206 for disposing the UV LED chip 208 is formed under the recess 204, and the recess 204 is for disposing the phosphor layer 216. A conformal light reflection layer 220 is formed over the surface of the substrate 202 exposed by the recesses 204 and 206, thereby forming a resonance chamber structure in the polarization white light emitting diode 200 for allowing multiple reflection of the light emitted by the UV LED chip 208 between the omni-directional reflector 124 and the light reflection layer 220 to excite the phosphor grains in the phosphor layer 216 and exhaust the energy of the UV light from the UV LED chip 208 to thereby improve light-wavelength conversion efficiency of the phosphor grains and make the polarized white light emitting diode 200 to emit more white light. The light reflection layer 220 may comprise reflective materials capable of reflecting UV light and visible light, such as Al, Cu, Au and Ag.

Herein, the UV LED chip 208 is disposed within the recess 206 formed in the substrate 202, and the recess 206 and portions of the recess 208 adjacent to the recess 206 are filled with the transparent layer 212 to entirely cover the UV LED chip 208. A phosphor layer 216 is provided in the recess 204 to cover the transparent layer 212. Composition of the phosphor layer 216 is the same with the phosphor layer 108 disclosed and described in FIG. 1. The transparent layer 212 can be epoxy resin or silicon resin which are transmissive to UV light and visible light. In addition, the polarized white light emitting diode 200 is provided with two spaced metal electrodes 210, respectively penetrating through the substrate 202 along opposite sidewalls thereof. The metal electrodes 210 respectively connect with an anode and a cathode (both not shown) of the UV LED chip 208 by a bond wire 214 and the UV LED chip 208 may emit UV light as a light source for exciting the phosphor layer 216 from a emission surface 209 of the UV LED chip 208 by applying currents on the metal pins 210.

In this embodiment, only a UV LED chip 208 is provided in the polarized white light emitting diode 200 and the UV LED chip 208 is covered by the transparent layer 212 to isolate the UV LED chip 208 from the phosphor layer 216. Therefore, material degradation of the phosphor layer 216 due to heat induced by UV light emitted from the UV LED chip 208 can be prevented and luminous efficiency and the luminous quality of the polarized white LED 200 are ensured.

In FIG. 6, the omni-directional reflector 124 is disposed over the phosphor layer 216 at a place opposite to the emission surface 209 of the UV LED chip 208. The omni-directional reflector 124 is spaced from the phosphor layer 124 by the medium 110. A metal-containing polarization layer 140 is formed over a surface 128 of the transparent substrate 122 opposite to the surface 126 of the transparent substrate 122. In this embodiment, the omni-directional reflector 124, the metal-containing polarization layer 140 and the transparent substrate 122 are the same with that disclosed in the embodiments illustrated by FIGS. 1 and 3 and are not described here in detail, for simplicity.

### Embodiment

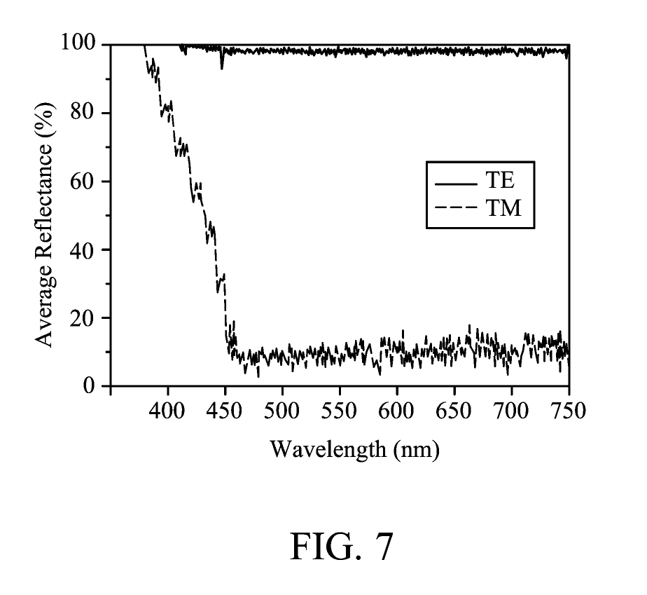

The polarized white LED 100 illustrated in FIG. 1 is provided, including a phosphor layer incorporating phosphor grains of blue, yellow and red colors, a UV LED chip, an omni-directional reflector including twenty layers of alternate deposition of high refractive index layers (made of Nb₂O₅ or TiO₂) and low refractive index layers (made of SiO₂), and a metal-containing polarization layer of a sub-wavelength aluminum metal grating having a period of about 100 nm. As shown in FIG. 7, an average reflectance (in a wavelength range of about 450-750 nm) simulation result of the sub-wavelength aluminum metal grating has a duty cycle of 50% and an incident angle of about 0-70 degrees is illustrated. Against all light incident angles, the metal-containing polarization layer shows a high average reflectance of over 90% to the TE light components and a low average reflectance of not more than 10% to the TM light components. A large reflectance difference exists between TM light components and TE light components of the white emitted by polarized white LED 100, which is advantageous for emitting polarized white light by the polarized white LED 100.

As discussed above, the polarized white LEDs of the invention have the following advantages.

1. The polarized white LED has high light uniformity, no color-shift and high color rendering.

2. With the use of the omni-directional reflector, luminous efficiency of the polarized white LED is improved and UV light emission is prevented.

3. Since the emitted light is polarized white light, glaring can be reduced and the polarized white LED is capable of luminous applications.

4. The metal-containing polarization layer is thermally stable and will not be degraded by heat, thereby functioning as a reliable polarizer.

5. The polarized white LED is suitable for luminous application and a polarizer sheet conventionally used in LCD displays can be eliminated when the polarized white LED is applied in backlight modules of LCD displays.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A polarized white light emitting diode (LED), comprising
a substrate with a circuit formed thereon;
an ultraviolet light emitting diode (UV LED) chip disposed over the substrate and electrically connected with the circuit, wherein the UV LED chip has an emission surface for emitting ultraviolet (UV) light;
a phosphor layer coated around the UV LED chip, wherein the phosphor layer is formed by blending multi-color phosphor grains with a transparent optical resin, and the multi-color phosphor grains in the transparent optical resin are excited by the UV light from the UV LED chip to thereby emit white light;
an omni-directional reflector disposed over the phosphor layer and opposite to the emission surface of the UV LED chip;
a medium layer disposed between the omni-directional reflector and the phosphor layer, wherein the medium layer has a refractive index of less than that of the phosphor layer and the omni-directional reflector for allowing the UV light from the UV LED chip to be multiply and omni-directionally reflected in between the phosphor layer and the medium layer;
a transparent substrate disposed over the omni-directional reflector, wherein the transparent substrate has opposite first and second surfaces, and the first surface of the transparent substrate is in contact with the omni-directional reflector; and
a metal-containing polarization layer disposed on the second surface of the transparent substrate, wherein the metal-containing polarization layer polarizes the white light emitted from the phosphor layer and passed through the transparent substrate to thereby emit a polarized white light.

2. The polarized white LED as claimed in claim 1, wherein the medium layer has a refractive index of about 1-1.5.

3. The polarized white LED as claimed in claim 2, wherein the medium layer comprises air.

4. The polarized white LED as claimed in claim 1, wherein the phosphor layer comprises phosphor grains of blue, yellow and red colors.

5. The polarized white LED as claimed in claim 1, wherein the omni-directional reflector is transmitted to the white light.

6. The polarized white LED as claimed in claim 1, wherein the metal-containing polarization layer is a sub-wavelength grating comprising a plurality of parallel arranged metal lines, and the metal lines have a period of 300 nm or less.

7. The polarized white LED as claimed in claim 1, wherein the metal-containing polarization layer is a sub-wavelength grating comprising a plurality of parallel arranged multilayer coatings, and the multilayer coatings comprise at least one metal layer and have a period of 300 nm or less.

8. The polarized white LED as claimed in claim 6, wherein the metal lines in the sub-wavelength grating have a duty cycle of about 10-60% ∘

9. The polarized white LED as claimed in claim 1, further comprising a reflective layer deposited on the top of the substrate whereon the UV LED chip was disposed, and the reflective layer and the omni-directional reflector form a pumping cavity structure allowing multiple reflections of the UV light.

10. The polarized white LED as claimed in claim 1, wherein the omni-directional reflector comprises a stack of alternate high reflective index layers having a reflective index of about 2-3 and low reflective index layers having a reflective index of about 1.4˜1.9.

11. A polarized white light emitting diode (LED), comprising
a reflective substrate having first and second recesses formed therein, wherein the first recess is formed below the second recess;
an ultraviolet light emitting diode (UV LED) chip disposed on the reflective substrate exposed by the first recess, wherein the UV LED chip has an emission surface for emitting ultraviolet light;
a transparent layer coated around the UV LED chip, filling the first recess;
a phosphor layer filling the second recess, covering the transparent layer, wherein the phosphor layer is formed by blending multi-color phosphors grains with a transparent optical resin, and the multi-color phosphor grains in the transparent optical resin are excited by the UV light emitted from the UV LED chip to thereby emit white light;
a pair of metal electrode formed through the second recess along opposite sidewalls of the reflective substrate, respectively;
a pair of bond wires connecting two of the metal electrodes with the UV LED chip, respectively;
an omni-directional reflector disposed over the phosphor layer and opposite to the emission surface of the UV LED chip;
a medium layer disposed in between the omni-directional reflector and the phosphor resin layer;
a transparent substrate disposed over the omni-directional reflector, wherein the transparent substrate has opposite first and second surfaces, and the first surface of the transparent substrate is in contact with the omni-directional reflector; and
a metal-containing polarization layer disposed on the second surface of the transparent substrate, wherein the metal-containing polarization layer polarizes the white light emitted from the phosphor layer and passed through the transparent substrate to thereby emit a polarized white light.

12. The polarized white LED as claimed in claim 11, wherein the medium layer has a refractive index of about 1-1.5.

13. The polarized white LED as claimed in claim 12, wherein the medium layer comprises air.

14. The polarized white LED as claimed in claim 11, wherein the phosphor layer comprises phosphor grains of blue, yellow and red colors.

15. The polarized white LED as claimed in claim 11, wherein the omni-directional reflector is transmitted to the white light.

16. The polarized white LED as claimed in claim 11, wherein the metal-containing polarization layer is a sub-wavelength grating comprising a plurality of parallel arranged metal lines, and the metal lines have a period of 300 nm or less.

17. The polarized white LED as claimed in claim 11, wherein the metal-containing polarization layer is a sub-wavelength grating comprising a plurality of parallel arranged multilayer coatings, and the multilayer coatings comprise at least one metal layer and have a period of 300 nm or less.

18. The polarized white LED as claimed in claim 16, wherein the metal lines in the sub-wavelength grating have a duty cycle of about 10-60% ∘

19. The polarized white LED as claimed in claim 11, further comprising a reflective layer deposited on the top of the substrate whereon the UV LED chip was disposed, and the reflection layer and the omni-directional reflector form a pumping cavity structure allowing multiple reflections of the UV light.

20. The polarized white LED as claimed in claim 11, wherein the omni-directional reflector comprises a stack of multilayers of alternate high reflective index layers having a reflective index of about 2-3 and low reflective index layers having a reflective index of about 1.4-1.9.
